(19) United States
(12) Patent Application Publication
(10) Pub. No.: US 2019/0346121 A1
(43) Pub. Date: Nov. 14, 2019

(54) LED LIGHT FIXTURE WITH OPTIONAL ADJUSTABLE PHOTOELECTRIC CONTROL

(71) Applicant: WSD LED INC., Dallas, TX (US)

(72) Inventor: Changyong Zhu, Shenzhen (CN)

(21) Appl. No.: 15/973,559

(22) Filed: May 8, 2018

(51) Int. Cl. F21V 21/14; H05B 37/02; F21S 8/00

(52) U.S. Cl. CPC F21V 21/14; F21Y 2115/10; F21S 8/00; H05B 37/02

(57) ABSTRACT

The present invention provides an LED light fixture with optional adjustable photoelectric control. It provides a convenient and cost-efficient apparatus and method to mount and un-mount photoelectric controls. It further provides angle adjustment of the photoelectric controls with respect to the light fixture. The present invention eliminates the needs for using electrical caps when the photoelectric controls are not selected. It also provides mounting apparatuses for mounting the light fixture on different structures.

### TECHNICAL FIELD

This invention relates to LED light fixtures. More specifically, this invention relates to outdoor LED light fixture with optional adjustable photoelectric control.

### BACKGROUND OF THE INVENTION

Outdoor lightings provide illumination solutions for numerous applications such as roadway, industrial, commercial, area, security and flood lighting. In addition to providing sufficient illuminations, modern outdoor lighting solutions increasingly focus on improvements on sustainability, environmental protection and energy efficiency, spurring technology development and bringing better outdoor lighting solutions that consume less energy consumptions and have better control.

Under this backdrop, light emitting diodes (LEDs) based lightings are increasing becoming the preferred lighting solutions for almost all kinds of lighting applications. Users select LEDs because of LEDs' many advantages comparing to conventional lighting such as incandescent, fluorescent, HID lighting etc., for example in terms of high lumen per watt, long lifespan, low voltage, low pollution during the manufacturing process etc.

In outdoor lighting, photoelectric controls may be used in conjunction with LED lights to further reduce energy consumption. Photoelectric control is generally a type of switch turned on or off based on the presence or absence of ambient light. Based on the different internal control modes, photoelectric controls may include thermal, electromagnetic and electronic types.

Photoelectric controls are usually presented to users as an optional feature. In the conventional art, LED light fixtures with photoelectric controls usually come with photoelectric control receptacles as a fixed part on the light fixture. When installed, the photoelectric control is inserted in the receptacle that matches the electrical pins of the control. Therefore, for each different model or different version of the same model of the photoelectric control, a different matching receptacle may be required to be incorporated to the light fixture, resulting in slow updates and/or inhibitively high costs for the LED light fixture manufacturers and users. In addition, for light fixtures with fixed receptacles, when a photoelectric control is not mounted therewith, the receptacles must be mounted with caps to reduce electrical and mechanical damages that may happen due to the open receptacles. Further, in the convention technology, the angle of the photoelectric control to the light fixture is fixed and cannot be adjusted. As such, the photoelectric control may receive insufficient lights in scenarios such as when the season changes, causing low performances of the photoelectric control system.

As such, it is desirable to have an LED outdoor lighting solution that is easy to install, does not require fixed receptacles for accommodating the photoelectric control, does not require the installation of caps when not used and is adjustable in its operating angle.

### SUMMARY OF THE INVENTION

Among the general objects of this invention is to provide an LED light fixture with optional photoelectric control.

Another object of the present invention is to provide an LED light fixture with adjustable photoelectric controls with respect to the light fixture.

Still another object of the present invention is to provide an LED light fixture with optional adjustable photoelectric control, wherein when the control is not opted, a simple cover, instead of caps, can be placed therein to protect the light fixture.

Yet another object of the present invention is to provide a cost-efficient LED light fixture with optional adjustable photoelectric control, wherein different types of the photoelectric control may be used interchangeably by choosing different socket adaptors.

Further another object of the present invention is to provide a cost-efficient LED light fixture with optional adjustable photoelectric control, wherein different mounting apparatus may be used interchangeably by choosing different mounting arms.

There are other objects of the present invention, which will be described in detail below and be understood by people of the ordinary art.

### BRIEF DESCRIPTION OF THE DRAWINGS

The above-mentioned advantages and other features of the present invention will become more apparent to and the invention will be better understood by people of ordinary skill of the art with reference to the following description of the preferred embodiments of the invention taken in conjunction with the accompanying drawings, wherein:

FIG. 1 is a top perspective view of a preferred embodiment of a LED light fixture with optional adjustable photoelectric control.

FIG. 2 is a top perspective view of the assembly mechanism between the illumination unit and mounting bridge according to a preferred embodiment of the present invention.

FIG. 3 is a close perspective view of the housing of the optional adjustable photoelectric control unit on the mounting bridge.

FIG. 4 is a perspective view of the optional adjustable photoelectric control base adaptor with its cover removed.

FIG. 5 is a close perspective view of the LED light fixture with a socket adaptor 515 mounted to the base adaptor.

FIG. 6A is a close perspective view of the LED light fixture mounted with the optional adjustable photoelectric unit that has the cover removed.

FIG. 6B is a close perspective view of the LED light fixture mounted with the optional adjustable photoelectric unit that has the cover attached.

FIG. 7 close perspective view of the LED light fixture without the optional adjustable photoelectric unit.

FIG. 8A is a close perspective view of the mounting arm unit of the LED light fixture configured to mount on flat structures.

FIG. 8B is a close perspective view of the mounting arm unit of the LED light fixture configured to mount on lampposts.

### DETAILED DESCRIPTION OF THE PREFERRED EMBODIMENTS

It is to be understood that all terminologies and phraseology used herein are for the purpose of illustrating, and should not be understood as limiting. The phrases such as “including”, “comprising”, “having” and other variations thereof are meant to encompass the items as described, their equivalents without excluding any additional items thereof. Terms such as “coupled”, “mounted”, “connected” and other variations thereof are meant to be interpreted broadly to include any coupling, mounting and connection, directly or indirectly with or without intermediate items.

The embodiments of the present invention will now be described in conjunction with the accompanying drawings. It will be apparent that the described embodiments are merely part of the embodiments of the invention and are not intended to be exhaustive. All other embodiments obtained by those of ordinary skill in the art are within the scope of the present invention, based on embodiments in the present invention.

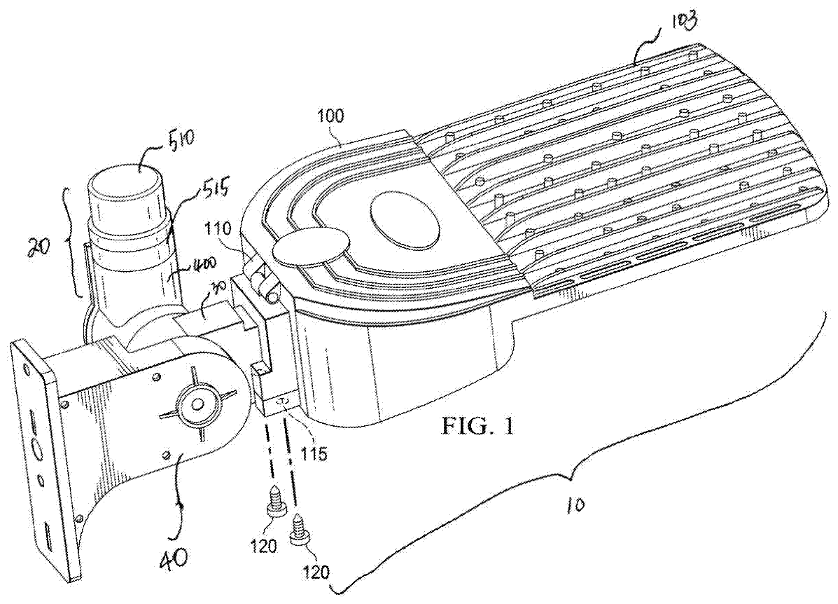

FIG. 1 is a top perspective view of a preferred embodiment of a LED light fixture with optional adjustable photoelectric control. Referring to FIG. 1, the LED light fixture with optional adjustable photoelectric control comprises an illumination unit 10, an optional adjustable photoelectric control unit 20, a mounting bridge 30, and a mounting arm unit 40. As illustrated in FIG. 1, the illumination unit 10 comprises a back panel 103 and a back cover 100. The illumination unit 10 further comprises an LED light array (not shown) that provides illumination. The LED light array is located on the opposite side of the back panel 103. Back cover 100 located next to the back panel 103 provides the housing for electrical wirings connecting the illumination unit 10 to the power source. It also provides housing for mechanical connections among the various parts of the illumination unit 10. At the end of the back cover 100, a pair of tabs 110 are located therein, connected to the mounting bridge 30. mounting bridge 30 provides central mounting bridge for the illumination unit 10, the optional adjustable photoelectric control unit 20 and the mounting arm unit 40. When all parts are assembled, the LED light fixture will be attached onto supporting structures such as walls of a building and lampposts in the street. The mounting arm unit 40 also provides electrical connections between the illumination unit 10 and the power source. The optional adjustable photoelectric control unit 20 is mounted to the mounting bridge 30, providing an optional adjustable photoelectric control that can be conveniently mounted or unmounted, providing a cost-efficient and advantageous method for incorporating or non-incorporating the photoelectric control. The connective mechanism among the various parts of the LED light fixture will be described in greater detail below in conjunction with the drawings 2-9.

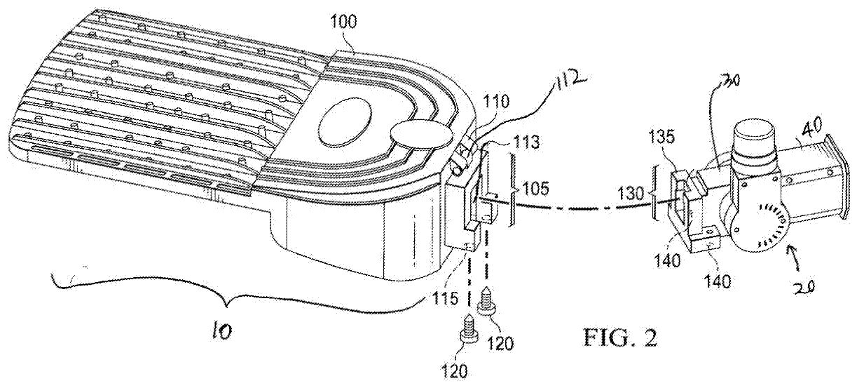

FIG. 2 is a top perspective view of the assembly mechanism between the illumination unit 10 and mounting bridge 30, according to a preferred embodiment of the present invention. Referring to FIG. 2, the assembly mechanism between the illumination unit 10 and mounting bridge 30 comprises a first part of the assembly mechanism 105 and a second part of the assembly mechanism 130. More specifically, at the top portion of the end to the back cover 100, a pair of tabs 110 is fixedly located therein. The pair of tabs 110 provides an anchor to the first assembly mechanism 105 between the illumination unit 10 and the mounting bridge 30. More specifically, the pair of tabs 110 has circular apertures on each of them, configured to receive a rod 112 extended across the pair of tabs 110 and through their respective apertures. The rod 112 is a part of and fixedly connected to the first part of the assembly mechanism 105. The first part of the assembly mechanism 105 further comprises a cutout portion 113 and a couple of screw holes 115 at the bottom portion of the first assembly mechanism 105, the function of which will be described in greater detail below.

The second part of the assembly mechanism 130 between the illumination unit 10 and the mounting bridge 30 is located at a first end of the mounting bridge 30. The second part of the assembly mechanism 130 comprises a protrusion portion 135 and a couple of screw holes 140 at the bottom portion of the second assembly mechanism 105. The protrusion portion 135 is configured to closely fit into the cutout portion 113, thereby connecting the first assembly mechanism 105 and the second assembly mechanism 130. When the protrusion portion 135 and the cutout portion 113 are fully connected to each other, the screw holes 115 and 140 will be aligned and allow a couple of screws 120 to be fastened through them, thereby securely fix the connections between the first part of the assembly mechanism 105 and the second party of the assembly mechanism 130.

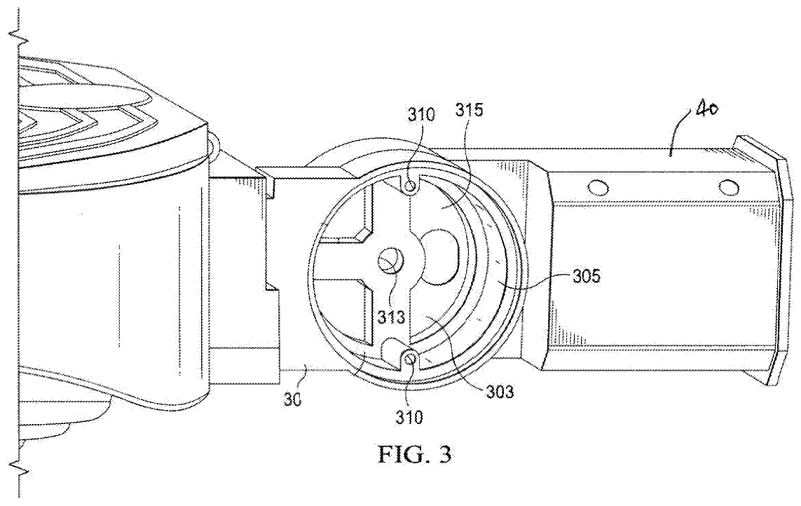

FIG. 3 is a close perspective view of the housing of the optional adjustable photoelectric control unit 20 on the mounting bridge 30. Referring to FIG. 3, next to the second assembly part 135 on the mounting bridge 30, a housing 315 of the optional adjustable photoelectric control 20 (not shown/installed) is configured therein. The housing 315 comprises a bottom 303 and a cylindrical wall 305. The bottom 303 and the cylindrical wall 303 form an open space for housing the optional adjustable photoelectric control unit 20. At the center of the bottom 303, an aperture 313 is located therein, providing a pathway for the wirings of the electrical connections of the LED light fixture to go through and connect to the power source. A wiring aperture 313 located on the bottom 303 allows the electrical wiring to go through. Two protrusions across the cylindrical wall 305 rise from therefrom, each containing a screw hole 310, which allows the optional adjustable photoelectric control unit 20 to be mounted to the housing 315 and adjusted in angle. The mounting and angle adjustment of the photoelectric control unit 20 will be described in further detail below.

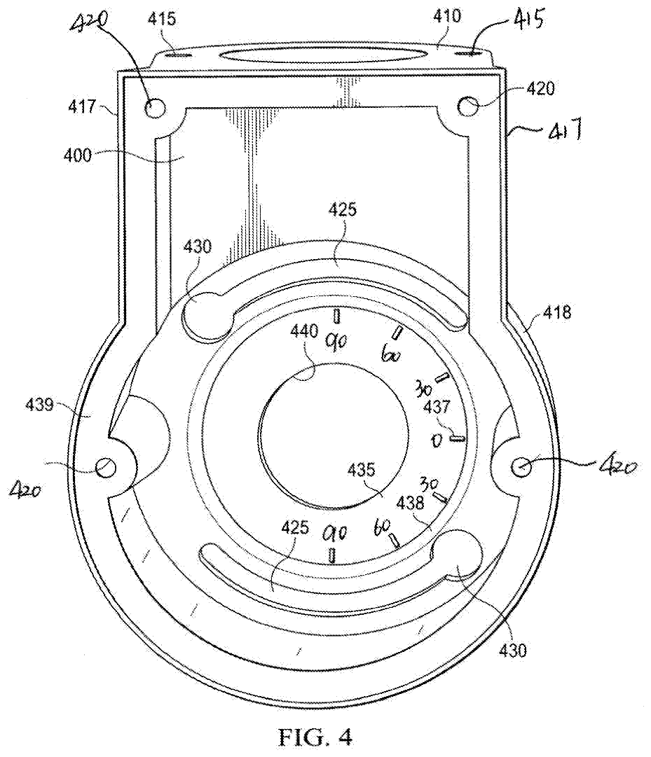

Now referring back to FIG. 1, the optional adjustable photoelectric control unit 20 comprises an optional adjustable photoelectric control base adaptor 400, a socket adaptor 515 and a photoelectric control 510, each component will be described in greater detail below. FIG. 4 is a perspective view of the optional adjustable photoelectric control base adaptor 400 with its cover removed. Referring to FIG. 4, the base adaptor 400 has a circular upper aperture 410 on the top thereof. The circular upper aperture 410 is configured to receive the socket adaptor 515. As will be described in detail below, the socket adaptor 515 is electrically communicative to the photoelectric control 510, which provides switching control to the illumination unit 10 based on the ambient lighting conditions if the photoelectric control unit 20 is selected. Two screw holes 415 are located across the aperture 410, configured to receive screws to fasten the socket adaptor 515 to the base adaptor 400. Two side walls 417 of the adaptor 400 extend downwards from the top portion of the base adaptor 400 and connect to a circular bottom wall 418 that connect the two side walls 417 at the bottom. The two side walls 417 and the circular bottom wall 418 delineate the external contour of the base adaptor 400.

The circular bottom wall 418 has substantially the same size as the housing 315 as illustrated in FIG. 3 and is configured to include and further extend the open space delineated by housing 315 when the base adaptor 400 is mounted thereto, providing an enclosure for the electrical wirings of the optional adjustable photoelectric control unit 20. At the center of the circular space delineated by the bottom wall 418, an aperture 440 is located therein to allow the electrical wirings of the optional adjustable photoelectric control unit 20 to go through. Around the aperture 440, a number of dials 437 are located thereof, configured to indicate a series of angles from −90 to 90 degrees with 30-degree intervals.

Outside of the dials, two arc-shaped apertures 425 are located on the top and bottom of the dials 437 respectively. According to a preferred embodiment of the present invention, the arc-shaped apertures 425 are of a length substantially corresponding to an angle of 90 degrees, although other angles can be chosen without departing from the scope of the current invention. The two arc-shaped apertures 425 are rotationally symmetrical, with each further comprising a wide head apertures 430 on one end of the apertures 425. The diameter of the head apertures 430 is configured to be larger than the head of the screws that fit into the screw holes 310 as illustrated in FIG. 3, whereas the width of the rest of the apertures 425 is configured to be smaller than the head of said screws but larger than the shank of the screws. As such, when two screws are put into the screw holes 310 but not fully tightened, the base adaptor 400 can be mounted to the mounting bridge 30 by locating the base adaptor 400 at the position where the heads of the screws can go through the head apertures 430, and rotating the adaptor 400 along the arc-shaped apertures 425 to the extent allowed by the length of the apertures 425. Due to that the width of the rest of the apertures of 425 is smaller than the heads of the screws, the base adaptor 400 can be affixed to the mounting bridge 30 therewith. Accordingly, the base adaptor 400 can be adjusted to an angle allowed by the length of the arc-shaped apertures 425, thereby allowing the photoelectric control 515 to be adjusted to an optimal angle within the range of the angles allowed by the apertures 425. As such, users can adjust from time to time the angle of the photoelectric control 515, which is advantageous over conventional photoelectric controls that are fixed to the housing of the LED light fixtures. It also provides for an easy way to dismount the optional adjustable photoelectric control unit 20 by rotating the unit and positioning the head apertures 430 to be aligned with the screws, whereby the optional adjustable photoelectric control unit 20 can come off. When the optional adjustable photoelectric control unit 20 is not selected, a cover covering up the housing 315 can be affixed to the mounting bridge 30 by putting screws into the screw holes 310. When the optional adjustable photoelectric control unit 20 is selected, the base adaptor is enclosed by a cover (not shown) fastened through screw holes 420.

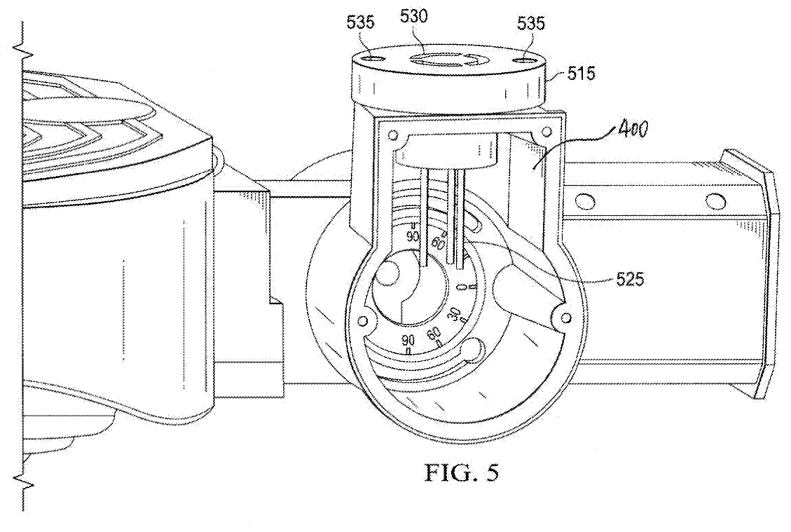

FIG. 5 is a close perspective view of the LED light fixture with a socket adaptor 515 mounted to the base adaptor 400. Referring to FIG. 5, the socket adaptor 515 comprises a set of electrical receptacles 530 and two apertures 535. The electrical receptacles 530 are configured to receive the electrical plugs from the photoelectric control 510. The electrical receptacles 530 may be configured to receive any type of plugs of the photoelectric control. For example, it can be configured to receive 3-phase electrical circular plugs. The electrical receptacles 530 may also be configured to receive 7-pin plugs allowing for WI-FI control. The electrical wirings for the photoelectric control 515 are contained in the free space within the base adaptor 400. The two apertures 535 are configured to be aligned with the screw holes 415, thereby securely mounting the socket adaptor 515 to the base adaptor 400.

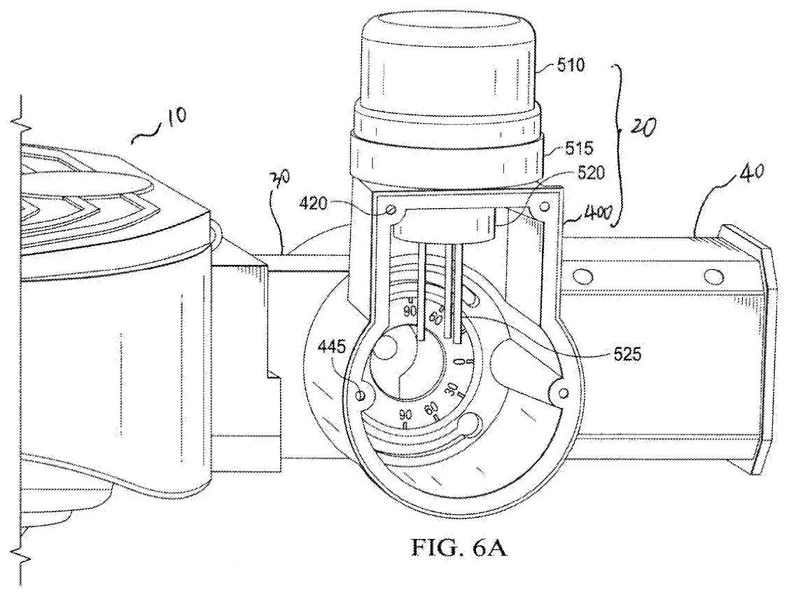

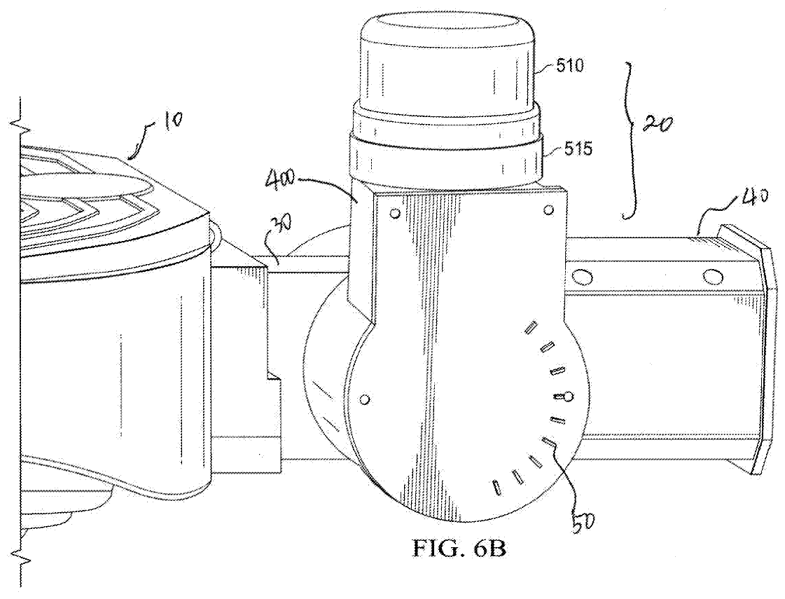

FIGS. 6A-6B are close perspective views of the LED light fixture mounted with the optional adjustable photoelectric unit 20. More specifically, FIG. 6A illustrates the mounted optional adjustable photoelectric unit 20 with the cover of the base adaptor 400 removed. FIG. 6B illustrates the mounted optional adjustable photoelectric unit 20 with the cover of the base adaptor 400 attached. On the cover of the base adaptor 400, there are a plurality of dials 550 configured to help the user identify the rotational degree of the optional adjustable photoelectric unit 20.

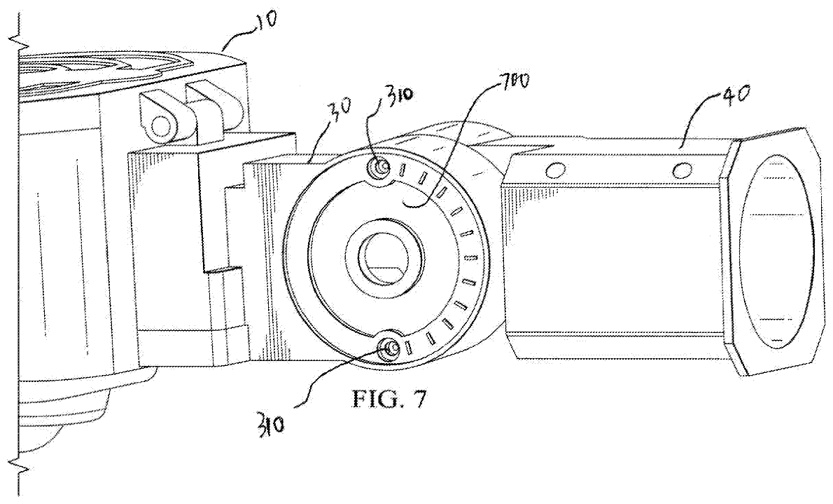

FIG. 7 close perspective view of the LED light fixture without the optional adjustable photoelectric unit 20. Referring to FIG. 7, when the photoelectric control is not selected, the photoelectric control unit 20 is not attached to the mounting bridge 30. Instead, a cover 700 is simply attached to the mounting apparatus 30 by fastening two screws into the screw holes 310, thereby closing off the open space contained in housing 315 as illustrated in FIG. 3 and other drawings. When the optional adjustable photoelectric control 20 is not selected, the housing 315 will simply allow the electrical wiring from the illumination unit 10 to go through, providing a cost-efficient solution for users or projects that choose not to have the photoelectric control. As such, the conventional shorting caps required to close off the circuit and receptacles when a conventional photoelectric control is not installed is no longer needed. As such, the present invention provides substantial cost savings for the users of the LED light fixture.

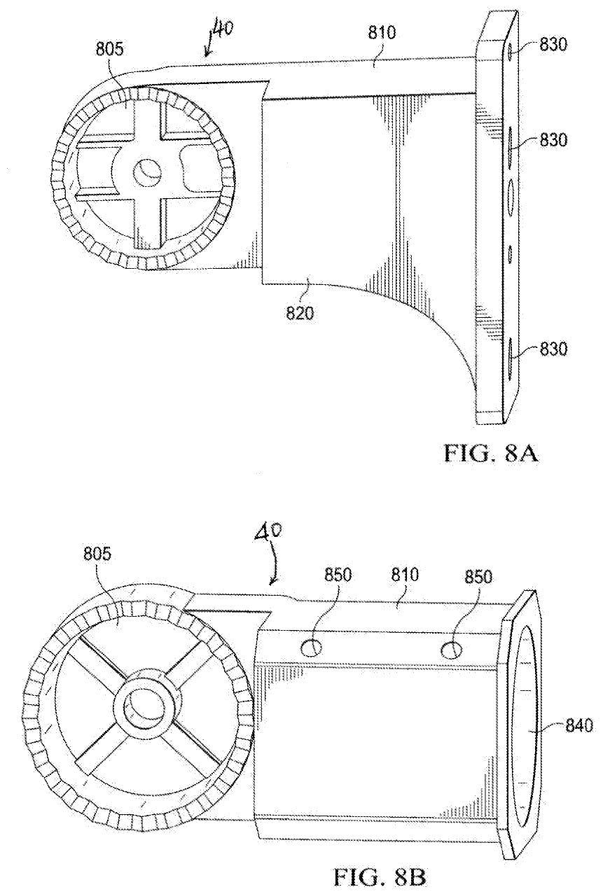

FIGS. 8A-8B are close perspective views of the mounting arm unit 40 of the LED light fixture according to preferred embodiment of the present invention. Referring to FIGS. 8A-8B, the mounting arm unit 40 comprises a first portion 805 and a second portion 810. The first portion 805 is of a circular shape, which is substantially the same dimension as the housing 315 of the mounting bridge unit 30. The edge of the first portion 805 is saw-shaped and is rotationally movable with respect to the mounting bridge unit 30. The second portion 810 is configured to mount to different types of structures. Referring to FIG. 8A, the second portion 810 comprises a tapered portion 820 that grows wider from the first portion 805 to the end the second portion 810. A few mounting holes 830 are located at the end of the second portion 810, allowing the light fixture to be mounted to walls. Referring to FIG. 8B, the diameter of the second portion 810 is uniform between the first portion 805 and the end of the second portion 810. On the second portion 810, a few screw holes 850 are located therein. An aperture 840 configured to attach to long apparatuses such as lampposts is located therein. It can be appreciated by people of the ordinary art that other designs of the second portion 810 can be provided to providing mounting mechanism between the light fixture and the mounted structure. The alternative designs are within the scope of the present invention.

The above descriptions of the embodiments of the present disclosure are provided for demonstration to persons skilled in the art, instead of exhaustively listing all the embodiments or limiting the present disclosure to a single disclosed embodiment. In view of the above, various replacements and variations to the present disclosure are apparent to persons skilled in the art. Therefore, although some alternative embodiments have been discussed in detail, other embodiments are apparent or can be readily derived by a person skilled in the art. The present disclosure is intended to cover all the replacements, modifications and variations to the present disclosure that have been discussed here as well as other embodiments consistent with the spirit and scope of the present disclosure.

1. An LED light fixture with optional adjustable photoelectric control, comprising:
an LED illumination unit;
an optional adjustable photoelectric control unit;
a mounting bridge; and
a mounting arm unit.

2. The LED light fixture with optional adjustable photoelectric control of claim 1, wherein the optional adjustable photoelectric control unit comprising:
a housing configured to alternatively receive at least one of a base adaptor, said base adaptor is configured to receive a photoelectric control when the photoelectric control is opted, and a cover, said cover is configured to close the housing when the photoelectric control is not opted.

3. The LED light fixture with optional adjustable photoelectric control of claim 2, wherein the base adaptor is configured to be rotationally adjustable with regard to the housing.

4. The LED light fixture with optional adjustable photoelectric control of claim 3, wherein the housing comprising a plurality of dials indicating an angle of degree the base adaptor is rotated with regard to the housing.

5. The LED light fixture with optional adjustable photoelectric control of claim 2, further comprising:
a socket adaptor comprising electrical receptacles configured to receive a plurality of plugs of the photoelectric control, wherein the socket adaptor is mounted on the base adaptor.

6. The LED light fixture with optional adjustable photoelectric control of claim 5, wherein the photoelectric control comprising three plugs.

7. The LED light fixture with optional adjustable photoelectric control of claim 1, wherein the mounting arm unit comprising:
a circular first portion; and
a second portion configured to mount to at least one of a wall and a lamppost.

8. The LED light fixture with optional adjustable photoelectric control of claim 1, wherein the LED illumination unit is configured for outdoor lighting.

9. The LED light fixture with optional adjustable photoelectric control of claim 1, wherein the mounting bridge is removably attached to the LED illumination unit, the optional adjustable photoelectric control unit and the mounting arm unit respectively.

10. A photoelectric control mounting apparatus for an LED light fixture, comprising:
a housing configured to alternatively receive at least one of a base adaptor, said base adaptor is configured to receive a photoelectric control when the photoelectric control is opted, and a cover, said cover is configured to close the housing when the photoelectric control is not opted,
wherein the housing is removably attached to a mounting bridge of the LED light fixture.

11. The photoelectric control mounting apparatus for an LED light fixture of claim 10, wherein the base adaptor is configured to be rotationally adjustable with regard to the housing.

12. The photoelectric control mounting apparatus for an LED light fixture of claim 11, wherein the housing comprising a plurality of dials indicating an angle of degree the base adaptor is rotated with regard to the housing.

13. The photoelectric control mounting apparatus for an LED light fixture of claim 10, further comprising:
a socket adaptor comprising electrical receptacles configured to receive a plurality of plugs of the photoelectric control, wherein the socket adaptor is mounted on the base adaptor.

14. The photoelectric control mounting apparatus for an LED light fixture of claim 13, wherein the photoelectric control comprising three plugs.

15. The photoelectric control mounting apparatus for an LED light fixture of claim 13, wherein the photoelectric control comprising seven plugs.

16. The photoelectric control mounting apparatus for an LED light fixture of claim 10, wherein a mounting art unit is removably attached to the mounting bridge.

17. The photoelectric control mounting apparatus for an LED light fixture of claim 16, wherein the mounting arm unit comprising:
a circular first portion; and
a second portion configured to mount to at least one of a wall and a lamppost.

18. The photoelectric control mounting apparatus for an LED light fixture of claim 10, wherein the LED illumination unit is configured for outdoor lighting.
